(19) United States
(12) Patent Application Publication
(10) Pub. No.: US 2009/0309736 A1
(43) Pub. Date: Dec. 17, 2009

(54) MULTIFUNCTION CONTACTLESS ELECTRONIC TAG FOR GOODS

(75) Inventor: Eric Heurtier, Dampierre (FR)

Correspondence Address: EDWARDS ANGELL PALMER & DODGE LLP, P.O. BOX 55874, BOSTON, MA, 02205, US

(73) Assignee: MPE Technology

(21) Appl. No.: 12/485,266

(22) Filed: Jun. 16, 2009

(30) Foreign Application Priority Data
Jun. 17, 2008 (FR) 0803366

(51) Int. Cl. G08B 13/14

(52) U.S. Cl. 340/572.8

(57) ABSTRACT

A system for managing the inventory of articles in a sales outlet, warehouse or production center. The system includes a computer and radioelectric network including a plurality of tags, each attached to an article and comprising a transceiver, an RFID chip and three antennae. The network also includes a computerized machine, a cash desk connected to the computerized machine, transmitter-receivers connected to the computerized machine, an anti-theft terminal comprising an alternating magnetic field transmitter, and an RFID transmitter capable of transmitting a signal received by the RFID chips of the tags. Each tag is also remote-controllable and provides an anti-theft function for the article to which it is attached. The tag is also able to display the price of the article and other information relating to the article.

### CROSS REFERENCE TO RELATED APPLICATION

This application claims priority to French Patent Application No. FR 0803366, filed Jun. 17, 2008, the entire contents of which are incorporated herein by reference.

### BACKGROUND OF THE INVENTION

1. Field of the Invention

The invention relates to a multifunction contactless electronic tag enabling the real-time tracking, inventory and display of prices of goods in stores, while providing an advanced anti-theft function.

2. Background of the Related Art

The primary concerns of sales outlet managers include taking inventory of goods, tracking goods, protecting goods against theft, and price re-tagging and discounting goods.

A first concern is the inventory of the articles in sales outlets. At the present time, although logistic chain information systems are increasingly high-performance, they provide lagged information with respect to customer demand. Indeed, sales outlet managers can only order missing goods on the basis of the cash desk reports produced on the evening of or the day following a day of sales. Moreover, during the opening hours of the sales outlet, it is difficult to determine whether the products are in the store or in stock due to the high number of customers. However, customers are increasingly volatile and no longer wait when the desired article is no longer on the store's shelves.

Also, it appears to be increasingly important for sales outlet managers to have a real-time inventory of the articles in the store. This real-time view of the store enables a manager to adjust the supply of the articles available on the shelves optimally to customer demand, and increase a particular article in the store on the basis of the sales strategy and demand.

Moreover, for tax reasons, it is important for managers of sales outlets or a chain of stores to have a very precise view of the stock. In the majority of cases, stock control actions are carried out by external companies or specialized personnel; they are expensive and can also be inaccurate.

To perform the inventory, it would be desirable to be able to identify and track articles in stores or in the stores' stock. At the present time, there is no effective and autonomous system making it possible to track a given article in a zone automatically. Tests have been conducted with systems based on High Frequency (HF) or Ultra High Frequency (UHF) Radiofrequency Identification (RFID) technologies, but these systems still require the involvement of a person with a reading tool to check the presence of an article at a short distance.

A second concern is product price tagging. During sale or specific promotional periods, the current legislation in some countries, requires store managers to re-tag all articles subject to the discount sales campaign. This long and tedious work is generally performed manually using either a small printer or a price tagging machine. The person in charge of re-tagging must re-tag each product individually, sometimes several times during sales periods when the price is reduced several times in succession. This manual re-tagging process prevents the set-up of instantaneous targeted promotions according to the activity of the sales outlet or the success of an article.

A third concern is the protection of articles against theft in the sales outlets. At the present time, an increasing number of anti-theft tags are integrated in the articles using one of the two following approaches: either the tag is integrated in a brand tag or the structural tag during the manufacture or packaging of the article (according to the source tagging principle), or the tag is added in distribution centers or on arrival in the sales outlets in the form of a hard tag attached to the articles using an attachment system comprising a stud or, for large articles, a strap.

Several types of anti-theft systems exist on the market. The two systems sold the most world-wide are, firstly, radiofrequency (RF) anti-theft systems with a coil antenna or a closed loop operating between 5 and 8.2 MHz, and, secondly, the acousto-magnetic system, with an element operating between 50 KHz and 58 KHz.

In anti-theft systems or “EAS” systems (electronic article surveillance), the tag comprises an antenna which returns a resonant signal when the tag moves through an alternating magnetic field wherein the frequency coincides with the resonance frequency of the antenna; this alternating magnetic field is supplied by terminals at the store exit. According to the prior art, the signal returned by the EAS antenna does not comprise an identifier.

None of these systems make it possible to anticipate a theft. Indeed, despite the dissuasive aspect of the hard tag, it does not emit an alert when the shoplifter tries to break same. Some more advanced systems integrate an ink cartridge which breaks and disperse ink on the article when the anti-theft device is damaged.

Electronic price display tags intended to be attached to the shelves (also referred to as store shelving tags) are known, wherein the display may be modified by a radiofrequency s signal or via infrared. The patent U.S. Pat. No. 6,269,342 (assigned to Telxon Corp.) and the patent application US 2005/0218218 (Koster) describe such a tag.

Electronic price display tags intended to be attached to the article are known, wherein the display may be modified by a radiofrequency signal, for example the devices described in the patent application WO 99/62269 or in the patents U.S. Pat. No. 6,307,919 and U.S. Pat. No. 7,178,727 (Yoked), or in the patent applications WO 02/063602 and WO 02/071382 (assigned to Visible Tech-Knowledgy, LLC).

Multifunction tags also exist. For example, the patent application WO 01/33526 (assigned to Motorola Israel Ltd.) describes a passive tag enabling the price display and theft protection of an article. The patent U.S. Pat. No. 5,151,684 (Johnsen) describes a semi-active tag enabling the price display and theft protection of an article; in the event of theft, this tag emits an audio signal.

The patent application US 2007/0024551 (Gelbman) describes an anti-theft tag for articles or baggage which has a remote-controllable display screen, and which may be tracked using GPS.

The problem addressed by the present invention is that of providing a contactless electronic tag which makes it possible both to identify and track remotely an article whereto it is attached, display the price of the article and modify said display remotely, and protect the article against theft, by actuating a detector when the article passes a boundary at the store exit.

### SUMMARY OF THE INVENTION

Advantages of the present invention will be set forth in and become apparent from the description that follows. Additional advantages of the invention will be realized and attained by the methods and systems particularly pointed out in the written description and claims, as well as from the appended drawings.

To achieve these and other advantages and in accordance with the purpose of the invention, as embodied herein, the invention includes a multifunction electronic module for tracking, theft protection, and price display of an article in a sales outlet. The module includes an attachment device configured to attach the module on an article; a switch actuated by the attachment device; a plurality of radioelectric antennae; a power source; a display screen; a radiofrequency transceiver; a microcontroller configured to control the display screen and the radiofrequency transceiver; an RFID chip connected to the microcontroller; and a plurality of quartz oscillators.

In one exemplary embodiment, the plurality of antennae include a first antenna associated with an anti-theft function, the first antenna operating at a frequency between 5 and 10 MHz and/or between 50 and 60 KHz; a second antenna associated with the RFID chip, the second antenna operating at a frequency between 12.5 and 15.5 MHz, or at a frequency between 800 MHz and 1 GHz; and a third antenna associated with the radiofrequency transceiver, the third antenna operating at a frequency between 10 kHz and 6 GHz, and preferably between 2.3 and 2.7 GHz.

The first, second, and third antenna may be either loop antennae or folded dipole antennae and may be located in the same plane. The module may be a flexible module and may include a device for detecting mechanical damage to the module. The function of the radiofrequency transceiver, RFID chip, and microcontroller may be ensured by an application specific integrated circuit (ASIC).

A method of using a multifunction electronic module in a sales outlet is also s disclosed. The method includes the steps of providing at least one transmitter-receiver capable of receiving signals from a radiofrequency transceiver; providing a multifunction electronic module that includes and attachment device, a display screen, a radiofrequency transceiver, a microcontroller configured to control the display screen and the radiofrequency transceiver, and an RFID chip connected to the microcontroller; attaching the module to an article using the attachment device; activating the module; sending a request for information relating to the article from the module via the RFID chip controlled by the microcontroller; receiving a first item of information in the RFID chip and recording the first item of information to the microcontroller of the module; sending a second item of information from the microcontroller to the display screen, wherein the second item of information is the same as, or a subset of, the first item of information; displaying the second item of information on the display screen; sending a request from the microcontroller to the transmitter-receiver via the radiofrequency transceiver; receiving a signal from the transmitter-receiver confirming that a reference to the article exists in an inventory database; connecting the module via the transceiver to the transmitter-receiver at a predetermined interval to send a presence signal and request information; receiving a third item of information from the transmitter-receiver consisting either of confirmation of the first item of information previously transmitted, or a fourth item of information, which is then processed by the microcontroller and displayed on the display screen.

In one exemplary embodiment, the method also includes the following steps: sending the first item of information from the RFID chip to a receiver associated with a cash desk of the sales outlet for removal of the module from the article, wherein the cash desk is linked with the inventory database; performing at least one of the steps of deleting the reference to the article in the inventory database and noting in the inventory database that the article has been sold; and detaching the module from the article.

A computer and radioelectric network for managing an inventory of articles in a sales outlet, warehouse or production center is also disclosed. The network includes a plurality of modules. Each module in the network is attached to an article and has been activated, and each module includes a transceiver capable of transmitting and receiving a radiofrequency signal, an RFID chip capable of receiving a radiofrequency signal, and three radioelectric antennae. A first antenna is associated with an anti-theft function, a second antenna is associated with the RFID chip, and a third antenna is associated with the radiofrequency transceiver. The network also includes a computerized machine housing an inventory database containing information on each of the articles to which an activated module in the network is attached. A cash desk station is and a plurality of transmitter-receivers are connected to the computerized machine. The plurality of transmitter-receivers are capable of exchanging signals with the radiofrequency transceiver of each of the plurality of modules in the network. An anti-theft terminal comprising a transmitter of an alternating magnetic field also forms a part of the network. The frequency of the alternating magnetic field coincides with the resonance frequency of the first antenna of each of the modules. The network also includes an RFID transmitter-receiver capable of transmitting a signal to, or receiving a signal from the RFID chip of the modules.

In one exemplary embodiment, the first antenna of the modules and the anti-theft terminal may operate at a frequency between 5 and 10 MHz, the second antenna of the modules and the RFID transmitter may operate at a frequency between 12.5 and 15.5 MHz, and the third antenna of the modules and the transmitters-receivers may operate at a frequency between 10 kHz and 6 GHz.

### BRIEF DESCRIPTION OF THE DRAWINGS

So that those skilled in the art to which the subject invention pertains will readily understand how to make and use the multifunction contactless electronic tag of the subject invention without undue experimentation, preferred embodiments of the invention will be s described in detail below with reference to the following figures:

FIG. 1 shows a block diagram showing the various elements of a multifunction contactless electronic tag according to an embodiment of the present invention, including a microcontroller with a control function (also referred to as an LCD Driver) of a liquid crystal screen, a transceiver, an RFID chip, and two of the three antennae, i.e. an antenna associated with the transceiver and an antenna associated with the RFID chip.

FIG. 2a shows a system for attaching a module or tag according to an embodiment of the invention, in the “closed circuit” position.

FIG. 2b shows a system for attaching a module or tag according to an embodiment of the invention, in the “open circuit” position.

FIG. 3a shows a front view of an exemplary embodiment of a tag according to the present invention.

FIG. 3b shows a side view of the module of FIG. 3a, illustrating the arrangement of the elements on the substrate of the tag.

FIG. 4 illustrates the tracking and inventory function of an exemplary embodiment of the tag of the present invention, including the signals transmitted by an antenna to a computerized machine (represented by the computer monitor on the right), which keeps an article inventory list.

FIG. 5 shows, for a specific embodiment, different displays available on the screen of the tag: the price of the article (X), its size (Y), promotional price information (Z), the former price (XX). A brand tag is also shown.

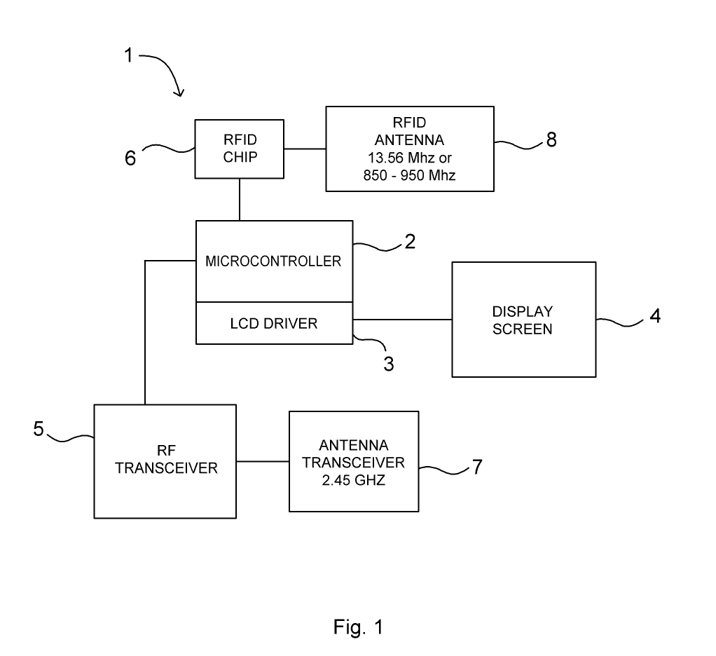

The following elements are shown in the drawings: a module or tag 1, a microcontroller 2, a screen control 3, a display screen 4, an RF transceiver 5, an RFID chip 6, an antenna 7 associated with transceiver, an antenna 8 associated with the RFID chip, an antenna 9 associated with an anti-theft function, an attachment device 10, a switch 11, a lever 12, an indicator light 13, a flat substrate 14, and a brand tag 15.

### DETAILED DESCRIPTION OF PREFERRED EMBODIMENTS

According to the invention, the problem is solved by associating on the same module or on the same electronic tag 1 an EAS antenna (anti-theft antenna) operating in radiofrequency mode, an RFID chip, a microcontroller configured to control a display screen and a radiofrequency transceiver. This avoids adding a second protection system on the product to be protected.

A first feature of the invention is the integration on the same electronic module or tag having three different antennae:

(i) A first antenna 9, associated with the anti-theft function (also referred to as EAS—Electronic Article Surveillance function), operates preferentially in RF mode a resonance frequency between 2 and 10 MHz, and more preferentially between 5 and 8 MHz and/or between 50 and 60 KHz (and in this case more preferentially at approximately 56-58 KHz). This antenna is advantageously a loop antenna capable of operating in radiofrequency mode, or an acousto-magnetic element, advantageously integrated inside the box or packaging. With a frequency in the range between 5 and 10 MHz and/or between 50 and 60 KHz, a detection distance between approximately 1 and 2 meters is obtained in passive mode, compatible with the EAS terminals commonly used in sales outlets. (ii) A second antenna 8, associated with the RFID chip 6, operates preferentially either in HF mode at a resonance frequency between 12.5 and 15.5 MHz (and in this case advantageously at 13.56 MHz), or in UHF mode at a resonance frequency between 800 MHz and 1 GHz, and in this case preferentially between 860 and 950 MHz.

(iii) A third antenna 7, associated with the radiofrequency transceiver 5, operates at a frequency between 10 kHz and 6 GHz, preferably at a higher frequency than the second antenna 8, and more advantageously at a frequency between 2.3 and 2.7 GHz, such as a frequency of approximately 2.45 GHz. This makes it possible to obtain a reading distance approximately between 5 and 60 meters in active mode, compatible for example with a WiFi terminal.

In one advantageous embodiment of the invention, these antennae 7,8,9 are loop or folded dipole antennae. It is possible to position each of the antennae on both faces of the same flat substrate 14, so as to reduce the overall surface area and volume of the final tag. It is also possible to position each of the antennae on the same surface of a flat substrate 14; in this case the antennae are all located in the same plane. In any case, a sufficient minimum distance between the antennae must be observed, so as not to disturb the proper operation thereof. It is also possible to place the same antenna on both faces of the same substrate 14, the partial electrical continuity between both antennae being provided by a bridge, which may be for example a mechanical crimping or a metal-coated hole.

The antennae 7,8,9 may for example be made of aluminum or copper, or made of any other suitable conductive material. They may be manufactured by means of a metal removal technology such as etching; or by depositing a conductive ink, for example by means of serigraphy; or by any other suitable technique.

In one embodiment of the module or tag, the anti-theft function is operated at a frequency of approximately 8.2 MHz and/or between 56 and 58 KHz, the RFID chip 6 at a frequency of approximately 13.56 MHz, and the RF transceiver 5 at a frequency of approximately 2.45 GHz. Each of the three antennae 7,8,9 is therefore aligned on one of these frequencies. In any case, and in particular whatever the frequency range of the antennae may be, one or more antennae can be integrated into the shell of the module 1.

A second essential feature of the invention is the link, via a microcontroller 2, between an RFID chip 6 and a radiofrequency (RF) transmitter-receiver 5, the latter being more commonly referred to as an “RF transceiver”, thus making it possible to encode each electronic module individually with a specific code for the article.

Indeed, one of the problems of standard transceivers on the market is the lack of flexibility thereof in terms of encoding. In the majority of cases, RF transceivers have a unique code that is non-modifiable or difficult to encode individually due to the reading range thereof Indeed, due to the large reading distance, the only means to encode them individually is to perform said encoding in a radio wave-tight space. This requires the information systems manager to create a connection table between the transceiver code and the article code. This is very restrictive and limits the association of transceivers with other products significantly as this may cause confusion in the databases. In the module according to the invention, the RFID chip, for example via a combined barcode and high frequency (HF) or ultra high frequency (UHF) writing system, makes it possible to transfer the article code to the RFID chip which records the article code in the memory of the RFID chip and transfers the article code into the memory of the microcontroller so that the article code can be transmitted via RF to the receivers installed in the store, by means of the transceiver. On the other hand, the electronic tag may perform, among other things, a real-time inventory function. In one exemplary embodiment, the frequency of the RF transceiver may be defined by a stabilized electronic oscillator, such as a quartz.

The module or tag 1 may comprise an RFID transponder, i.e. an RFID chip 6 connected to an antenna 8. The abbreviation RFID, well-known to those skilled in the art, means Radio Frequency Identification. The RFID transponder is advantageously a passive transponder. It serves to receive external data. With a frequency in the range between 12.5 and 15.5 MHz, a reading distance between approximately 0.1 m and 1 m is obtained; with a frequency between 800 MHz and 1 GHz, it is preferable to adapt the shape and size of the antenna 8 so as not to exceed a reading distance of approximately 1 to 2 m.

The tag or module may comprise a microcontroller 2 provided with a memory unit. The microcontroller has several functions. It handles via the transceiver 5 the transmission, reception and storage of data relating to the article to which it is, or will be, affixed. Furthermore, it controls a display screen 4 making it possible to display part or all of the data transmitted. The microcontroller 2 also comprises a quartz or an RC oscillator.

In one embodiment, at least the functions of the RF transceiver 5, of the RFID chip 6 and of the microcontroller 2 are represented by an application specific integrated circuit (ASIC).

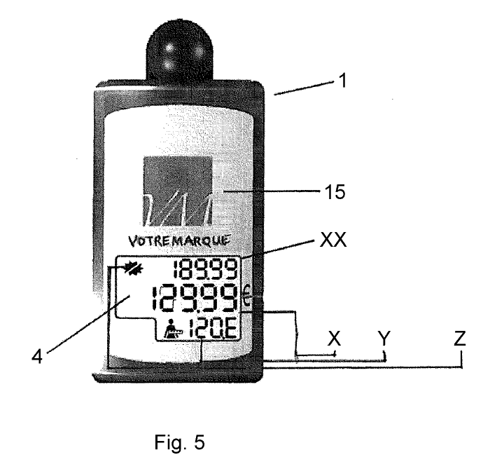

The module or tag may be equipped with a display screen 4, which typically consists of a Liquid Crystal Display (LCD) screen. Other existing or future display technologies may be used, such as electronic paper. These low energy consumption display technologies are preferred. The function of the display screen 4 is to display information. This may consist of information intended for the customer to whom the article whereon the tag is attached is intended (for example the normal price or the sale price, or both at the same time), the size of the article (for example for clothing, shoes, gloves or hats), or the sell-by date thereof (in the case of fresh or perishable products). This is illustrated in FIG. 5. This may also consist of information intended for store personnel handling the tag, for example information on the module battery status, and on the tag reception or transmission status; this information may be displayed using alphanumeric characters or using pictograms. Some information, such as the power source charging status, may also be viewed using an indicator light 13 (such as an LED—Light Emitting Diode).

The functions of the screen 4 are managed by the microcontroller 2. The number of screen segments must be compatible with the capacity of the microcontroller 2.

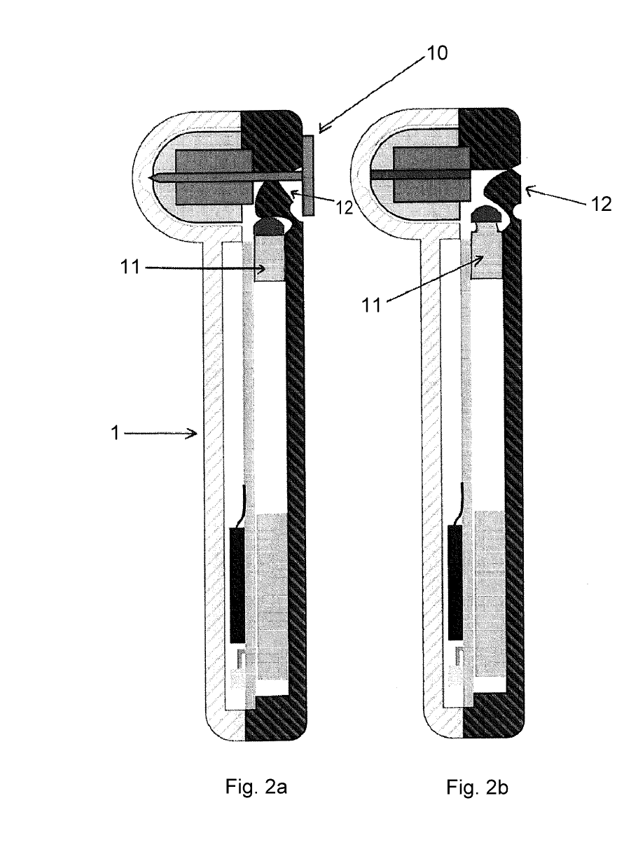

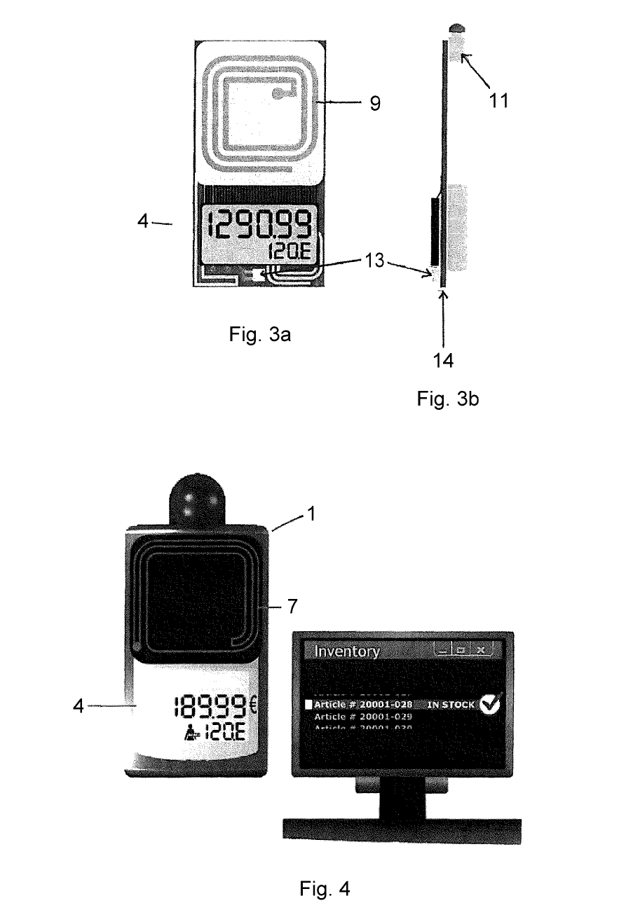

The tag or module 1 according to the invention must be able to be attached to an article. Any suitable attachment device 10 may be used, such as a chain, a cable, a stud or a strap. According to the invention, the attachment device activates, directly or indirectly, a switch 11. In one exemplary embodiment, the attachment device is used to attach the module or tag 1 on an article by means of an engagement or closure mechanism, and the switch 11 is actuated by closing, engaging, opening, releasing or removing the attachment device 10. The attachment device 10 may be a stud which actuates, via a lever 12, a switch 11. An example of an embodiment is shown in FIG. 2. In another embodiment, the switch 11 is actuated by a suitable detector, which may be an optical detector or other detector capable of detecting either the presence or absence, or the opening or closure of the attachment device. This makes it possible to combat the theft of articles equipped with the tag: via a presence detection module, or via the switch 11, the tag may continuously verify the presence or closure of the attachment device 10 on the article. Once the switch 11 is actuated, or once the presence detector detects an attempted detachment, the microcontroller 2 verifies the presence or absence of the attachment device, or the opening or closure of the attachment device. If the closure means has not been opened or removed at the store cash desk and the separation action proves to be attempted theft, the microcontroller 2, via the transceiver 5, reports the theft.

Indeed, the electronic module, via the switch 11, makes it possible to determine whether the attachment device 10 is still fitted. When the shoplifter attempts to break the attachment device, for example by applying sufficient pressure on the stud 10 so that the stud gives way, the electronic tag 1 sends an alarm to the security manager to report attempted damage. Using the article tracking, the security manager is thus able to locate the approximate location of the theft within the store.

The tag or module 1 comprises a power source, which may be a battery, a rechargeable battery, or a photovoltaic cell, optionally associated with an electricity storage means.

In one exemplary embodiment, to limit the energy consumption, the electronic tag 1 may switch to sleep mode when the attachment means has been opened during the sale of the article. Indeed, in order to increase the service life of the tag and the number of rotations thereof, during the entire period wherein the tag is not associated with an article, the tag 1 will be set to a standby or off mode. At the same time, the memory module of the microcontroller 2 clears the memory of the microcontroller to avoid any confusion in terms of encoding at the time of activation or reactivation of the module or tag.

When the tag 1 is associated with an article, and after having been activated, the tag returns a previously recorded recognition code (typically the article code or EAN code) to the receiver in the sales outlet to signal the presence of the article. Indeed, the sales outlet comprises at least one receiver, and preferentially a plurality of receivers, capable of receiving the signal transmitted by the RF transceiver 5. This makes it possible to determine the position of the articles in the various points of the sales outlet, but also in the ancillary premises such as the stock.

At a time interval that is either preset, or determined by a store manager, the electronic tag 1 notifies the manager of the presence of the tag and by extension, the article to which the tag is attached. The time interval may be periodic, and is controlled by the microcontroller 2. This time interval may be determined by the sales outlet or warehouse managers.

In this way, at selected intervals, the sales outlet manager or store warehouse manager will have a precise view of the number of articles present in the sales outlet, and may determine, on the basis of the data, the average presence time of a series of the same article, making it possible to anticipate future sales.

The attachment device 10 of the tag 1 must not alter the article to which it is fitted. It is possible to use a stud which is inserted in the module 1 by piercing through the article (or the packaging thereof); such an attachment system is known per se.

Once the attachment device 10 is engaged or closed, for example, once the stud is associated with an article and engaged in the module, the module 1 will be set automatically by freeing the access to the memory of the RFID chip 6. Using a standard RFID reader-transmitter, which may be a portable transmitter, or a fixed transmitter, the user will be able to transfer the article code in the electronic tag 1. Once the information is transferred, the RFID chip 6 will close the access to its memory of in order to prevent any attempted fraud or any accidental modifications.

Once the electronic tag 1 has been associated with the article and once the article code and the other associated information such as the price or size have been transferred into the memory of the RFID chip 6, the RFID chip 6 will transfer the information relating to the article to the microcontroller 2 so that the electronic tag 1 can connect to a receiver of the network and notify the sales outlet of the presence of the tag. During this first connection, the electronic tag notifies the network of its presence. This makes it possible to subsequently track the entire service life of the product automatically in the store.

The module or tag may be used as part of a computerized and radioelectric network for managing articles in a sales outlet, warehouse or production. This network includes a plurality of N modules or tags (E1, . . . ,EN) 1 as described above, each of the modules or tags E being attached to an article and having been activated; a computerized machine C comprising a database, herein referred to as “inventory list”, of articles whereto one of the N activated modules or tags E 1 is attached; at least one cash desk station K connected to said computerized machine C; a plurality of M transmitters-receivers (R1, . . . ,RM) capable of exchanging signals with said radiofrequency transceiver 5 of said module or said tag E 1, and connected to said computerized machine C; at least one anti-theft terminal B comprising a transmitter of an alternating magnetic field wherein the frequency coincides with the resonance frequency of the first antenna 9 of the tags or modules E 1; at least one RFID transmitter-receiver capable of transmitting or receiving a signal received by or transmitted to said RFID chip of the tags or modules E 1.

The transmitters-receivers R (these two functions may be separate, in which case a plurality of transmitters and a plurality of receivers are required, and this case is herein inferred in the term “transmitter-receiver”) which are positioned in the store make it possible to detect the electronic tags, and make it possible to create a sales outlet inventory list image. In this way, they store all product-related information. When a manager changes the price of an article or a series of articles, this modification is transmitted remotely, for example via Ethernet cable or a radioelectric (contactless) transmission means from the back office or from the front office of the store to the receivers. When an electronic tag connects to a receiver, said receiver informs the tag when a new data item has arrived and transfers same, via the radiofrequency transceiver, to the electronic tag 1. The information arriving in the tag 1 is then recorded in the microcontroller 2, which displays the information automatically, in part or in whole, on the screen 4 of the tag 1.

This makes it possible to automate the price display of the electronic tag. The dynamic display of the price and other information on the article on sale in the sales outlet offers advantages particularly during promotional or sales periods. The display means 4 of the tag 1 may be used to display both the initial price of the product and the new sale price. At the present time, during sales periods, consumers are often only informed of a percentage discount, as manual price re-tagging operations are relatively time consuming to carry out. The computerized machine C is typically a computer, such as a Personal Computer.

Another important aspect of the invention is the management of collisions at the receivers in the computerized and radioelectric network. Indeed, the frequency bandwidths usually used in the range between 2.3 and 2.7 GHz (for example 2.45 GHz) are relatively narrow and thus limit a plurality of RF readings in a defined field.

However, in a sales outlet, in a warehouse or in a production center, the number of articles may be very high and may exceed 10,000 articles. If all these products communicate at the same time, a bottleneck will occur at reception level and the transfer of the information to the receivers.

In order to limit these collision problems, the connection timing of an electronic tag to the receiver is determined by the time at which the tag is activated by engaging or closing the attachment device (for example by inserting the anti-theft stud in the electronic tag). As it is very unlikely that a large number of electronic tags will be activated at the same time, the synchronization timing of the tags with the receivers will therefore be different between tags. The frequency range between 2.3 and 2.7 GHz is preferred, as it offers a high connection speed, greater, less than or equal to 2 Mbits per second to transfer between 96 bits and 1 kbit, according to the application. This high communication speed with respect to the volume of data, in addition to the desynchronization of the tags with respect to each other makes it possible significantly limit collision problems, thus ensuring satisfactory automatic transfer of information to the electronic tags. A data transfer rate of at least 256 kbits per second, and preferably of at least 2 Mbits per second, is preferred.

The module or tag 1 may have various forms. This may consist for example of a module in the form of a box, having a thickness of up to, for example, 5 mm or more, or a flat tag having a smaller thickness, and optionally having some mechanical flexibility.

In one embodiment, the tag or module 1 is a flexible tag, with all electronic components, antennae and screens having been deposited onto one or more flexible substrates, typically made of polymeric material. Such a tag 1 can also include a power source that is mechanically flexible, such as a photovoltaic cell deposited onto a flexible substrate, or a flexible thin film battery.

In another embodiment, the electronic part of the tag or module 1 is integrated in a plastic molded part. The plastic molded part may have on the front face thereof a slot for inserting a brand tag 15 of the store to display the brand logo or other information. The brand tag 15, in order to be visible but protected from soiling, may be coated on the outer part thereof by a transparent plastic shell. The plastic shell surrounding the product may be devised so as not to allow the power supply battery to be removed from the electronic module. Indeed, for security reasons, the majority of store managers will not wish for the customers to be able to deactivate the electronic tag 1 by removing the battery.

To offer more security for the product 1, the anti-theft system operates in passive mode, that is, even if the product is no longer powered by the battery, the anti-theft system would still function. This would make it possible to still apprehend shoplifters at the store exit.

In one exemplary embodiment, the rear face of a shell of the module or tag 1 is not transparent and is interchangeable by means of a specific key. This makes it possible, firstly, to perform maintenance operations on the electronic part, change the batteries or change the shell, if it has been damaged. This will enable, secondly, the sales outlet manager to reuse the module or tag 1 without having to purchase another one. The service life of the electronic tag 1 according to the invention is dependent on the service life of the power supply battery in the tag, and is typically between 2 and 5 years. If the product 1 is not externally damaged, simply changing the battery will make it possible to reuse same for an equivalent period.

In another embodiment, the module or tag 1 comprises a device for detecting mechanical damage. The damage-detection device is capable of emitting a signal when the module or tag 1 suffers mechanical damage. The damage-detection device is especially capable of detecting any damage to or destruction of the module or tag 1 by a person trying to deactivate the tag and/or separate the tag from the article to which it is attached. In one exemplary embodiment, the damage-detection device comprises an electrically conductive line. If the electrical continuity of the line is interrupted or altered, the damage-detection device will emit a signal, such as an acoustical or electronic signal, which informs the store manager or the security manager that somebody is trying to destroy the module or tag 1. The computerized and radioelectric network as described above allows the store or security manager to localize said module or tag 1 in order to identify the shoplifter. The electrically conductive line can be installed at an appropriate place, such as inside the shell of the module or on the substrate on which the antennae and/or electronic components are deposited.

The use of the module 1 within the computerized and radioelectric network will now be described. In one exemplary embodiment, a sales outlet equipped with a cash desk and at least one receiver capable of receiving signals from the radiofrequency transceiver 5 of the module or tag 1 is used. The receiver may be a transmitter-receiver. The method of using the module within the network may include the following steps: (a) a module or a tag 1 according to the invention is provided; (b) the module or tag is attached to the article using the attachment device; (c) the module or tag 1 is activated, with activation being performed by engaging or closing the attachment device 10, which actuates the switch 11 or a presence detector which may be integrated in the module or tag 1; (d) the module or tag 1 sends the request for information relating to the article via the RFID chip 6; (e) the user sends an item of information I1 to the article using an RFID transmitter. The information may be the article code, with or without the price of the article, with or without the features of the article; (f) the item of information I1 relating to the article is received and recorded in the RFID chip 6 of the module or tag 1; (g) the RFID chip 6 records the item of information I1 in the microcontroller 2. The microcontroller 2 sends an item of information I relating to the display screen 4, this item of information I being either identical to the item of information I1, or consists of a subset of the item of information I1. This information on the article may be a specific article code, and/or the price of the article. The information on the article displayed by the display screen 4 is not necessarily identical to that transmitted by the user, it may be less comprehensive. For example, if the item of information I comprises the article code and the price, it will typically be sufficient to display the price, as the article code is not necessary for the customer, but only for the store manager. The item of information I may also comprise the size of the article (clothing, for example), or the sell-by date thereof; (h) the display screen 4 displays the item of information I; (i) Once the item of information I1 has been received, the microcontroller 2 sends a request to the receiver (which may be a transmitter-receiver) via the transceiver 5; (j) A transmitter-receiver sends a signal confirming the referencing of the article in a database called “inventory list”; (k) The tag 1, via the transceiver 5, connects at regular or irregular intervals to the transmitter-receiver to send a presence signal and request information; (l) the transmitter-receiver sends an item of information J consisting either of the confirmation of the item of information I1 previously transmitted, or a new item of information 12, which is then processed as for the item of information I1 in steps (f),(g),(h) and (i).

The update of the item of information I1 by sending a new item of information I2 particularly relates to the price, which may vary according to the store's sales policy. In the event of a promotional price change, the item of information I2 may comprise both the old price, which was included in the item of information I1, and the new price, optionally specifying that the old price is not valid. Indeed, in some countries, the current regulations require sales outlets to display, in the case of promotional selling price reductions, both the old price and the new price, to enable the consumer to ensure that the promotional nature of the new price is genuine. The item of information I2 may also include the price reduction, expressed as a percentage of the new, promotional price with respect to the previous, regular or promotional price. In this method according to the invention, steps (g) to (i) may be performed later, but must be performed in this order.

The method for use according to the invention may also comprise the following steps: (m) when the article is sold to a customer of the sales outlet, the item of information I1 is sent by the RFID chip 6 to a receiver associated with the cash desk of the sales outlet or to the system for removing the module or tag 1 from the article, said cash desk or said system being linked with the inventory list; (n) the article is deleted from the inventory list or is marked in the inventory list as being sold; and (o) the module or tag is detached from the article, typically by a member of cash desk or security staff. The switch is then activated, but this does not result in an alert as the article is no longer included in the list of products for sale, as it is either deleted from the inventory list or marked in said list as being sold.

In one exemplary embodiment, the modification of the price displayed by the electronic tag 1 associated with the article will be performed automatically when the electronic tag 1 connects to the RF receivers via the transceiver 5 on the tag. Indeed, the RF receivers integrate the sales outlet back office information. When a price is modified in the back office system of the sales outlet, an item of information will be sent to the transceiver-receivers so that they automatically modify the price display in the electronic tag 1. This automation of the price display assists store managers in determining the right price of an article according to the sales volume.

The anti-theft function of the module or tag may be accomplished in various ways, different from what has been described above. As an example, the RFID chip 6 can be used in a passive mode as anti-theft device. According to prior art, the anti-theft function can be obtained by resonators operating at frequencies between 25 and 125 kHz, and especially between 56 and 58 kHz, or at a frequency between 5 and 15 MHz. According to the invention, one can use the passive RF functions of the module or tag as an anti-theft device. These passive RF function are usually in frequency range between 12 and 16 MHz, and especially around 13.56 MHz, on the one hand, and in the high frequency range, especially between 850 and 950 MHz, on the other hand. They can be used as an anti-theft device when the modules or tags enter in resonance with the magnetic field created by the anti theft terminals B located at the exit of the store. Indeed, these RF functions can be activated when the module or tag 1 enters into the radiofrequency magnetic field of the terminals B, triggering an alarm signal, acoustic or other, if the module or tag 1 has not been removed from the article, or deactivated.

In yet another embodiment, the anti theft function is based on a specific information (such as a bit called an EAS bit) integrated into the circuit of the RFID chip 6 operating at low frequency and /or high frequency. This EAS bit can only be deactivated at the cash desk station K; as long as the EAS bit has not been deactivated, it will be identified by the anti theft terminals B and trigger an alarm signal.

The present invention, as described above and shown in the drawings, provides for multifunction contactless electronic tag and the use of such a tag within a network. It will be apparent to those skilled in the art that various modifications and variations can be made to the present invention without departing from the scope of the invention as outlined in the appended claims and their equivalents.

The invention claimed is:

1. A multifunction electronic module for tracking, theft protection, and price display of an article in a sales outlet, the module comprising:
an attachment device configured to attach the module to an article;
a switch actuated by the attachment device;
a plurality of radioelectric antennae;
a power source;
a display screen;
a radiofrequency transceiver;
a microcontroller configured to control the display screen and the radiofrequency transceiver;
an RFID chip connected to the microcontroller; and
a plurality of quartz oscillators.

2. The module of claim 1, wherein:
a first antenna is associated with an anti-theft function;
a second antenna is associated with the RFID chip; and
a third antenna is associated with the radiofrequency transceiver.

3. The module of claim 2, wherein the first antenna operates at a frequency between 5 and 10 Mhz.

4. The module of claim 2, wherein the first antenna operates at a frequency between 50 and 60 KHz.

5. The module of claim 2, wherein the second antenna operates at a frequency between 12.5 and 15.5 MHz.

6. The module of claim 2, wherein the second antenna operates at a frequency between 800 MHz and 1 GHz.

7. The module of claim 2, wherein the third antenna operates at a frequency between 10 KHz and 6 GHz.

8. The module of claim 2, wherein the third antenna operates at a frequency between 2.3 and 2.7 GHz.

9. The module of claim 2, wherein the first, second, and third antenna are selected from the group consisting of loop antennae and folded dipole antennae.

10. The module of claim 2, wherein the first, second, and third antenna are located in the same plane.

11. The module of claim 1, wherein the attachment device is used to attach the module to an article by means of an engagement mechanism, and wherein the switch is actuated by removing the attachment device.

12. The module of claim 1, wherein the function of the radiofrequency transceiver, the RFID chip, and the microcontroller are ensured by an application specific integrated circuit.

13. The module of claim 1, further comprising a device for detecting mechanical damage.

14. The module of claim 1, wherein the module is a flexible module.

15. A method of using a multifunction electronic module in a sales outlet, the method comprising:
providing at least one transmitter-receiver capable of receiving signals from a radiofrequency transceiver;
providing a multifunction electronic module that includes an attachment device, a display screen, a radiofrequency transceiver, a microcontroller configured to control the display screen and the radiofrequency transceiver, and an RFID chip connected to the microcontroller;
attaching the module to an article using the attachment device;
activating the module;
sending a request for information relating to the article from the module via the RFID chip controlled by the microcontroller;
receiving a first item of information in the RFID chip and recording the first item of information to the microcontroller of the module;
sending a second item of information from the microcontroller to the display screen, wherein the second item of information is the same as, or a subset of, the first item of information;
displaying the second item of information on the display screen;
sending a request from the microcontroller to the transmitter-receiver via the radiofrequency transceiver;
receiving a signal from the transmitter-receiver confirming that a reference to the article exists in an inventory database;
connecting the module via the transceiver to the transmitter-receiver at a predetermined interval to send a presence signal and to request information;
receiving a third item of information from the transmitter-receiver consisting of either a confirmation of the first item of information previously transmitted, or a fourth item of information, which is then processed by the microcontroller and displayed on the display screen.

16. The method of claim 15, further comprising:
sending the first item of information from the RFID chip to a receiver associated with a cash desk of the sales outlet for removal of the module from the article, wherein the cash desk is linked with the inventory database;
performing at least one of the steps of deleting the reference to the article in the inventory database and noting in the inventory database that the article has been sold; and
detaching the module from the article.

17. The module of claim 1, wherein the module is configured for use in protecting the article against theft.

18. A computer and radioelectric network for managing an inventory of articles in a sales outlet, warehouse or production center, the network comprising:
a plurality of modules, each module being attached to an article and having been activated, wherein each module comprises a transceiver capable of transmitting and receiving a radiofrequency signal, an RFID chip capable of receiving a radiofrequency signal, and three radioelectric antennae, wherein a first antenna is associated with an anti-theft function, a second antenna is associated with the RFID chip, and a third antenna is associated with the radiofrequency transceiver;
a computerized machine including an inventory database containing information on each articles to which one of the activated modules is attached;
a cash desk station connected to the computerized machine;
a plurality of transmitter-receivers connected to the computerized machine and being capable of exchanging signals with the radiofrequency transceiver of the module;
an anti-theft terminal comprising a transmitter of an alternating magnetic field, wherein the frequency coincides with the resonance frequency of the first antenna of each of the modules; and
an RFID transmitter-receiver capable of transmitting or receiving a signal received by or transmitted to the RFID chip of the modules.

19. The network according to claim 18, wherein the first antenna of the modules and the anti-theft terminal operate at a frequency between 5 and 10 MHz, the second antenna of the modules and the RFID transmitter operate at a frequency between 12.5 and 15.5 MHz, and the third antenna of the modules and the transmitters-receivers operate at a frequency between 10 kHz and 6 GHz.

20. The network according to claim 19, wherein the third antenna of the modules as well as the transmitter-receivers, operate at a frequency between 2.3 and 2.7 GHz.
